(19) United States
(12) Patent Application Publication
(10) Pub. No.: US 2009/0300148 A1
(43) Pub. Date: Dec. 3, 2009

(54) Configuration data deployment control systems and methods

(76) Inventor: A. Ferdinand Gomes, Novi, MI (US)

Correspondence Address: UNISYS CORPORATION, UNISYS WAY, MAIL STATION: E8-114, BLUE BELL, PA, 19424, US

(21) Appl. No.: 12/319,032

(22) Filed: Dec. 31, 2008

Related U.S. Application Data
(60) Provisional application No. 61/029,091, filed on Feb. 15, 2008.

(51) Int. Cl. G06F 15/177

(52) U.S. Cl. 709/220; 713/1

(57) ABSTRACT

Methods and systems of controlling distribution of configuration data are disclosed. One method includes receiving a request for configuration data for storage in a memory of a programmable circuit useable in a device, the configuration data controlling one or more operational characteristics of the device. The method also includes determining operational capabilities of the device based on the contents of a configuration database. The method further includes generating a single-use configuration data file. The configuration data file containing configuration data includes an identifier of the device, an identifier of the programmable circuit, and configuration data configured to define operational characteristics of the device. Various encryption techniques can be employed as well.

### RELATED APPLICATION

This application claims the benefit of U.S. Provisional Patent Application Ser. No. 61/029,091, filed Feb. 15, 2007, entitled “CONFIGURATION DATA DEPLOYMENT CONTROL SYSTEMS AND METHOD” by Gomes. This application is incorporated in its entirety herein.

### TECHNICAL FIELD

The present disclosure relates to deployment of software systems. In particular, the present disclosure relates to control of deployment of configuration data, such as for use in programmable devices.

### BACKGROUND

Electronic and electromechanical devices, such as printers, scanners, mechanical drive mechanisms, or other embedded systems that execute software or firmware instructions can include configuration data which dictates certain variable aspects of their operation. This configuration data can set threshold operating parameters of a device, or can enable or disable certain features in the device. These electronic and electromechanical devices are subject to failure of their electrical systems, including the components relying on and storing the configuration data. Portions of these devices, such as the electrical components contained therein, must be replaced upon failure.

When electrical components are replaced in such a device, analogous configuration data needs to be stored in memory of the replacement components to maintain the same operational capabilities of that device after components are replaced. The configuration data is generally stored into a read/write memory upon replacement of the components within the device. Due to the read/write capability of the memory in which the configuration data is stored, and the fact that configuration data files are readily transferable, that configuration data can potentially be copied into subsequent replacement parts. Furthermore, the configuration data dictating operational parameters of a device can be altered in the memory of that device, allowing users or third parties to grant operation capabilities to their devices that may be different from that authorized by the manufacturer.

Manufacturers of the electronic and electromechanical devices that employ configuration data prefer, in certain instances, to limit the replication of configuration data for use with only the replacement components in the original device, rather than replication of that configuration data in other devices. This may be because sets of operational capabilities defined by the configuration data may be sold at different prices, or that certain devices require configuration data including a specific variable based on specialized mechanical or electrical components included in that device. However, the manufacturer's ability to control distribution of this data is limited.

For these and other reasons, improvements are desirable.

### SUMMARY

In accordance with the following disclosure, the above and other problems are solved by the following:

In a first aspect, a method of controlling distribution of configuration data is disclosed. The method includes receiving a request for configuration data for storage in a memory of a replacement programmable circuit useable in a device, the configuration data controlling one or more operational characteristics of the device. The method also includes determining operational capabilities of the device based on the contents of a configuration database. The method further includes generating a single-use configuration data file. The configuration data file containing configuration data includes an identifier of the device, an identifier of the replacement programmable circuit, and configuration data configured to define operational characteristics of the device.

In a second aspect, method of controlling distribution of configuration data is disclosed. The method includes receiving a single-use configuration data file containing configuration data. The configuration data includes an identifier of the device, an identifier of the replacement programmable circuit, and configuration data configured to define operational characteristics of the device. The method further includes determining a match between the identifier of the replacement programmable circuit in the configuration data file and an identifier of the replacement programmable circuit in a memory of the replacement programmable circuit. The method also includes determining whether the replacement programmable circuit has previously been used.

In a third aspect, a system for controlling distribution of configuration data defining operational capabilities of a device is disclosed. The system includes an identifier matching module configured to determine a match between an identifier of a replacement programmable circuit in a configuration data file and an identifier of the replacement programmable circuit in a memory of the replacement programmable circuit. The system also includes a use detection module configured to determine whether the replacement programmable circuit has previously been used. The system further includes a storage module configured to store configuration data from the configuration data file into the memory of the replacement programmable circuit.

In a fourth aspect, a system for controlling distribution of configuration data defining operational capabilities of a device is disclosed. The system includes a request receipt module configured to receive a request for configuration data. The configuration data is used for storage in a memory of a replacement programmable circuit useable in a device and controlling one or more operational characteristics of the device. The system also includes a determination module configured to determine operational capabilities of the device based on the contents of a configuration database. The system further includes a generation module configured to generate a configuration data file containing configuration data. The configuration data includes an identifier of the device, an identifier of the replacement programmable circuit, and configuration data configured to define operational characteristics of the device.

### BRIEF DESCRIPTION OF THE DRAWINGS

FIG. 1 illustrates an example configuration data deployment network in which aspects of the present disclosure may be implemented;

FIG. 2 is a block diagram of an example document processing system incorporating a programmable control system that is replaceable using the configuration data deployment control systems and methods of the present disclosure;

FIG. 3 illustrates a general purpose computing system for use in implementing as one or more computing embodiments of the present disclosure;

FIG. 4 is a schematic diagram of initial replacement of a control board in a document processing system, according to a possible embodiment of the present disclosure;

FIG. 5 is a schematic diagram of completed replacement of a control board in a document processing system, according to a possible embodiment of the present disclosure;

FIG. 6 is a schematic diagram of distribution of configuration data for programming a system according to a possible embodiment of the present disclosure;

FIG. 7 illustrates an example configuration file useable to program a document processing system, according to a possible embodiment of the present disclosure;

FIG. 8 illustrates example data records in a configuration database, according to a possible embodiment of the present disclosure;

FIG. 9 shows a flowchart illustrating a process for controlling deployment of configuration data using the systems and methods of the present disclosure; and

FIG. 10 shows a flowchart illustrating a process for programming a system using the configuration data deployment systems and methods of the present disclosure.

### DETAILED DESCRIPTION

Various embodiments of the present disclosure will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many embodiments possible.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits.

In general, the present disclosure relates to methods and systems for controlling distribution of configuration data defining operational capabilities of a device. According to the various embodiments of the present disclosure, use of configuration data can be controlled by requiring systems using that configuration data to match identifiers, such as serial numbers set by a supplier of the configuration data or device. Additional details regarding particular implementations of the present disclosure will become more apparent in conjunction with the various aspects described below.

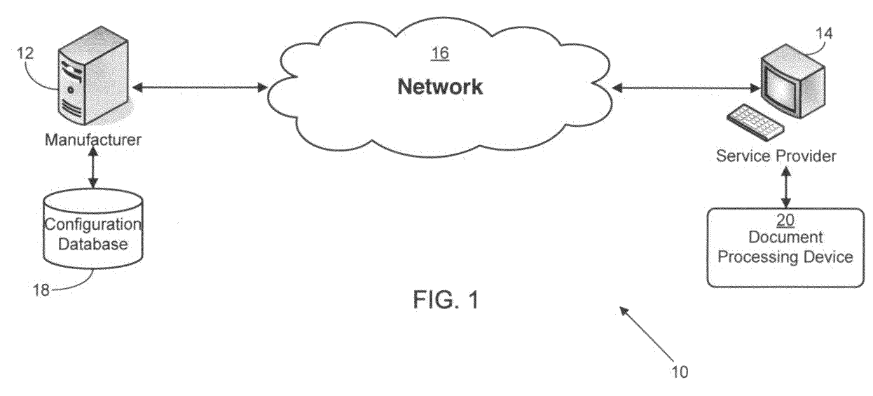

FIG. 1 illustrates an example configuration data deployment network 10 in which aspects of the present disclosure may be implemented. The data deployment network 10 generally shows interconnections between a manufacturer 12 and service provider 14, allowing the manufacturer and service provider to communicate data therebetween. The manufacturer 12 communicates with the service provider 14 via a network 16, which can be the Internet or some similar local or wide area network. The manufacturer 12 corresponds generally to a company that manufactures and/or supplies electrical or electromechanical devices, and also optionally supplies replacement parts for those devices. The replacement parts can include, for example, replacement circuit boards or other programmable circuits or control systems used within the devices made/distributed by the manufacturer.

The service provider 14 generally corresponds to a field service entity that, generally under prior agreement with the manufacturer 12, can perform service on or repair the devices and device components distributed by the manufacturer. The service provider 14 can therefore correspond to a third party entity (i.e. not the manufacturer or a purchaser of the manufacturer's products) who either resells components on the behalf of the manufacturer, or can reprogram devices or components of devices (e.g. programmable circuits, such as replacement circuit boards).

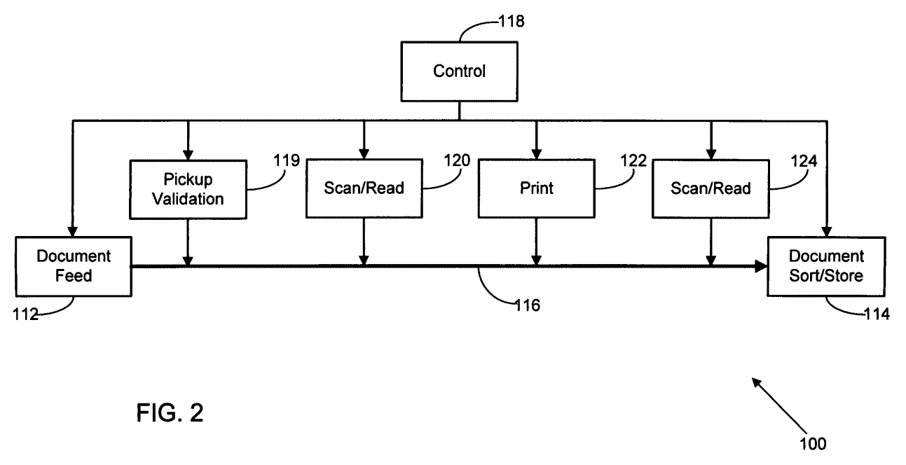

The manufacturer 12 manages a configuration database 18, which tracks the various configurations of devices sold by the manufacturer. The configuration database 18 contains configuration data relating to the devices sold, by tying an identifier for each device with a set of configuration parameters. The configuration data stored in the configuration database can correspond to any of a variety of types of data that can enable/disable or set specific operational parameters of a device. In certain embodiment described herein, the device can be a document processing system, such as an automated document processing system. In such cases, configuration data can, for example, include variables to enable or disable scanning, optical character recognition, franking rollers, or other devices. The configuration data can also set threshold values for throughput, input capacity, output configuration, or other variables. A generalized example document processing system schematically illustrating features adjustable via configuration data is described below in conjunction with FIG. 2.

The identifier included in the configuration database 18 can correspond to a serial number or other unique identifier of the device or component of that device (e.g. a programmable circuit). The identifier can correspond to other identifier types as well, such as a unique tracking number, hardware address, or other variable.

The service provider 14 operates on a device, shown as a document processing device 20. The document processing device 20 represents any of a variety of devices capable of receiving and storing configuration data in memory. This configuration data, as previously mentioned, can set specific operational values of the device, which may be purchased at different prices by purchasers of the device. An example of a document processing system that can correspond to the document processing device 20 is described below in conjunction with FIG. 2.

Referring now to FIG. 2, a document processing system 100 is shown. The document processing system 100 incorporates a programmable control system that is replaceable, such as by using the configuration data deployment control systems and methods of the present disclosure. The document processing system 100 provides an overview of the basic steps required to process documents, such as checks, in a high-volume system in which user supervision is minimized.

In one embodiment, the document processing system 100 is a check processing system used to print and scan checks at a financial institution or document processing company. The document processing system 100 includes a document feeder 112 interconnected with a document sorter along a path of travel 116 of documents. The document feeder 112 is generally a document take-up mechanism provided with a large number of documents that are required to be processed. In a possible embodiment, the document feeder 112 receives 600 or more documents, such as checks, for processing. The document sorter 114 is an endpoint at which the documents have been processed, and can include one or more sorting mechanisms and/or document receiving apparatus configured to arrange physical documents in a desired manner. The document sorter 114 places processed documents into one or more pockets, each of the pockets holding a number of processed documents.

The path of travel 116 may be defined by any of a number of document movement and/or guiding mechanisms, such as rollers, guides, or other systems able to grip and move documents from the document feeder 112 to the document sorter 114. A control system 118 is interconnected to the document feeder 112 and the document sorter 114 to control flow of documents along the path of travel 116.

The control system 118 can be an application level program or firmware resident on the system 100 configured to control flow and processing of documents. The control system 118 can reside on a general purpose or specific purpose computing system capable of communicating with the document feeder 112 and document sorter 114. The control system 118 can reside (alternately or in part) in a memory of a programmable circuit resident within the document processing system 100. In certain embodiments, the control system 118 is executed on a circuit board interfaced with various electrical and electromechanical systems, as described below. Although the document processing system 100 is described in conjunction with a number of product functions, it is understood that the control system and related circuitry can enable or disable certain portions of the document processing system.

The control system 118 directs operation of a validation system 119. The validation system 119 validates the actions of the document feeder 112 to ensure that documents are fed into the path of travel 116 properly. The validation system 119 generally detects occurrences where multiple documents are taken up into the path of travel by the document feeder 112, and can comprise a number of configurations of opto-electronic components, such as light emitting diodes, phototransistors, or other devices, according to various embodiments of the present disclosure. The various configurations may be variably enabled or disabled through use of configuration data which can allow or disallow functionality of the system.

The control system 118 further directs a scanning system 120 and a printing system 122. The scanning system 120 can scan one side of the documents passing along the path of travel 116, to store text and/or images displayed on the documents. The printing system 122 prints desired characters and/or images onto documents passing by the printing system along the path of travel 116. The printing system 122 can incorporate a print assembly which is configured to print from a stationary printing aperture onto moving documents passing by the printing system along the path of travel. In the example of a check processing system, the printing system 122 can print an endorsement onto the back of a check which is being processed at a financial institution operating the automated document processing system 100. Other documents may be processed as well, by financial institutions or other document processing entities.

Other functionalities may be incorporated along the path of travel 116, such as additional scanning, printing, or character reading systems. Each of these functionalities can be directed by the control system 118, and may be enabled or disabled using configuration data loaded into and used in conjunction with the control system. The existence of any of these additional systems is a matter of system configuration, depending upon the needs of the institution using the system.

By passing documents through the document processing system 100, a large volume of documents can be printed and electronically captured, such that various records can be stored for each of a large number of documents. In the case of a financial institution processing checks or other documents, that institution can endorse a large number of checks, can capture check images and routing information, and can appropriately sort the document for distribution back to the issuing institution of the check.

Furthermore, although the control system 118 is described in conjunction with a document processing system, it is understood that similar control systems using configuration data can be incorporated into a variety of other types of devices, such as printers, scanners, electronic control units (ECUs), computer peripherals, and other devices.

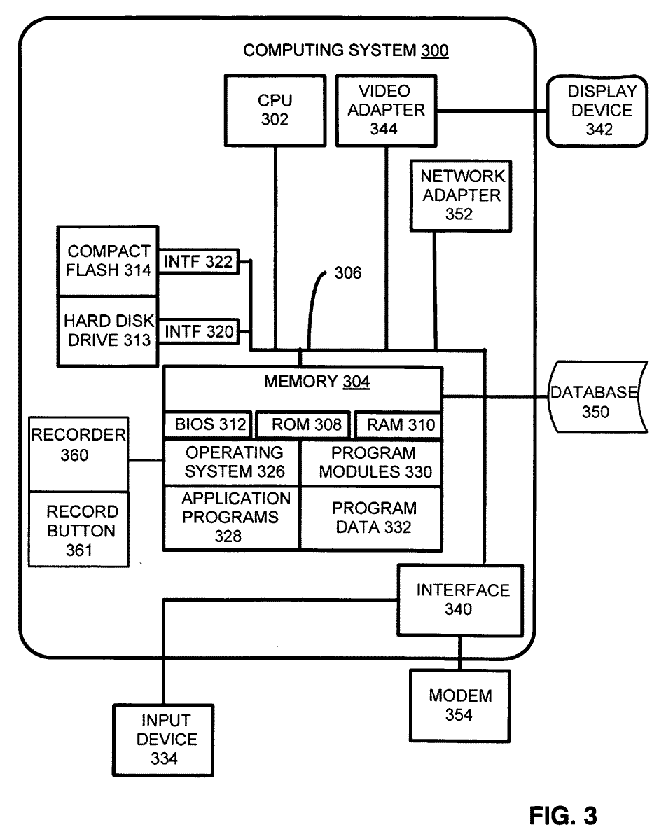

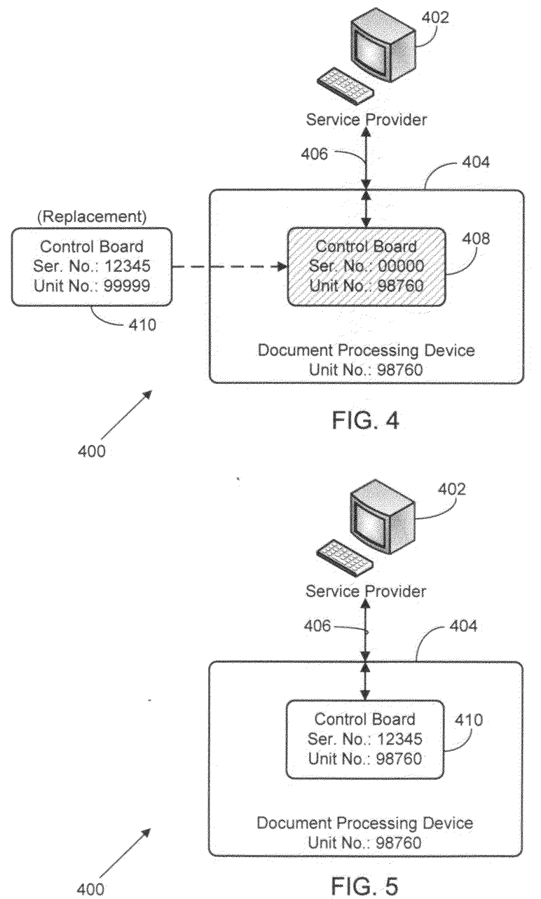

Referring to FIG. 3, an exemplary environment for implementing embodiments of the present disclosure includes a general purpose computing device in the form of a computing system 300, including at least one processing system 302. In the various embodiments described herein, the general purpose computing device can correspond to the various computing devices of FIG. 1, such as that of the manufacturer 12 or service provider 14. The computing system 300 can provide functionality for performing aspects of the present disclosure reflected in the systems and methods disclosed in FIGS. 4-10. A variety of processing units 302 are available from a variety of manufacturers, for example, Intel or Advanced Micro Devices. The computing system 300 also includes a system memory 304, and a system bus 306 that couples various system components including the system memory 304 to the processing unit 302. The system bus 306 might be any of several types of bus structures including a memory bus, or memory controller; a peripheral bus; and a local bus using any of a variety of bus architectures.

Preferably, the system memory 304 includes read only memory (ROM) 308 and random access memory (RAM) 310. A basic input/output system 312 (BIOS), containing the basic routines that help transfer information between elements within the computing system 300, such as during start up, is typically stored in the ROM 308.

Preferably, the computing system 300 further includes a secondary storage device 313, such as a hard disk drive, for reading from and writing to a hard disk (not shown), and/or a compact flash card 314.

The hard disk drive 313 and compact flash card 314 are connected to the system bus 306 by a hard disk drive interface 320 and a compact flash card interface 322, respectively. The drives and cards and their associated computer readable media provide nonvolatile storage of computer readable instructions, data structures, program modules and other data for the computing system 300.

Although the exemplary environment described herein employs a hard disk drive 313 and a compact flash card 314, it should be appreciated by those skilled in the art that other types of computer-readable media, capable of storing data, can be used in the exemplary system. Examples of these other types of computer-readable mediums include magnetic cassettes, flash memory cards, digital video disks, Bernoulli cartridges, CD ROMS, DVD ROMS, random access memories (RAMs), read only memories (ROMs), and the like.

A number of program modules may be stored on the hard disk drive 313, compact flash card 314, ROM 308, or RAM 310, including an operating system 326, one or more application programs 328, other program modules 330, and program data 332. A user may enter commands and information into the computing system 300 through an input device 334. Examples of input devices might include a keyboard, mouse, microphone, joystick, game pad, satellite dish, scanner, digital camera, touch screen, and a telephone. These and other input devices are often connected to the processing unit 302 through an interface 340 that is coupled to the system bus 306. These input devices also might be connected by any number of interfaces, such as a parallel port, serial port, game port, or a universal serial bus (USB). A display device 342, such as a monitor or touch screen LCD panel, is also connected to the system bus 306 via an interface, such as a video adapter 344. The display device 342 might be internal or external. In addition to the display device 342, computing systems, in general, typically include other peripheral devices (not shown), such as speakers, printers, and palm devices. The computing system 300 can also interface with an external database 350, such as a data store resident on a separate computer or peripheral device.

When used in a LAN networking environment, the computing system 300 is connected to the local network through a network interface or adapter 352. When used in a WAN networking environment, such as the Internet, the computing system 300 typically includes a modem 354 or other means, such as a direct connection, for establishing communications over the wide area network. The modem 354, which can be internal or external, is connected to the system bus 306 via the interface 340. In a networked environment, program modules depicted relative to the computing system 300, or portions thereof, may be stored in a remote memory storage device. It will be appreciated that the network connections shown are exemplary and other means of establishing a communications link between the computing systems may be used.

The computing system 300 might also include a recorder 360 connected to the system memory 304. The recorder 360 includes a microphone for receiving sound input and is in communication with the system memory 304 for buffering and storing the sound input. Preferably, the recorder 360 also includes a record button 361 for activating the microphone and communicating the sound input to the system memory 304.

A computing device, such as computing system 300, typically includes at least some form of computer-readable media. Computer readable media can be any available media that can be accessed by the computing system 300. By way of example, and not limitation, computer-readable media might comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium that can be used to store the desired information and that can be accessed by the computing system 300.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media. Computer-readable media may also be referred to as computer program product.

Referring now to FIGS. 4-5, schematic diagrams of initial and completed replacement of a control board in a document processing system is shown according to a possible embodiment of the present disclosure. These Figures depict a maintenance testbench 400, which generally corresponds to a maintenance configuration used by a manufacturer or a service provider to perform maintenance on a device, such as a document processing system.

The maintenance testbench 400 includes a maintenance system 402 and a device, shown as a document processing device 404. The maintenance system 402 can be any of a number of types of generalized computing systems, such as the computing system described above in conjunction with FIG. 3. The maintenance system 402 interfaces with the document processing device 404 at an interface 406, and in turn with a control board installed within the document processing device. The interface 406 can correspond to any of a number of wired or wireless test connections; in certain embodiments, the interface 406 corresponds to a serial data communication interface connecting a control board to the maintenance system, such as a USB or Firewire interface.

The document processing device 404 corresponds generally to the document processing device 100 of FIG. 2, with the integrated control board providing the control functionality for the device. In FIG. 3, the control board installed into the document processing device 404 is an original control board 408, which is shown as requiring replacement by a replacement control board 410. In FIG. 4, the replacement control board is installed into the document processing device 404, and the original control board 408 has been discarded.

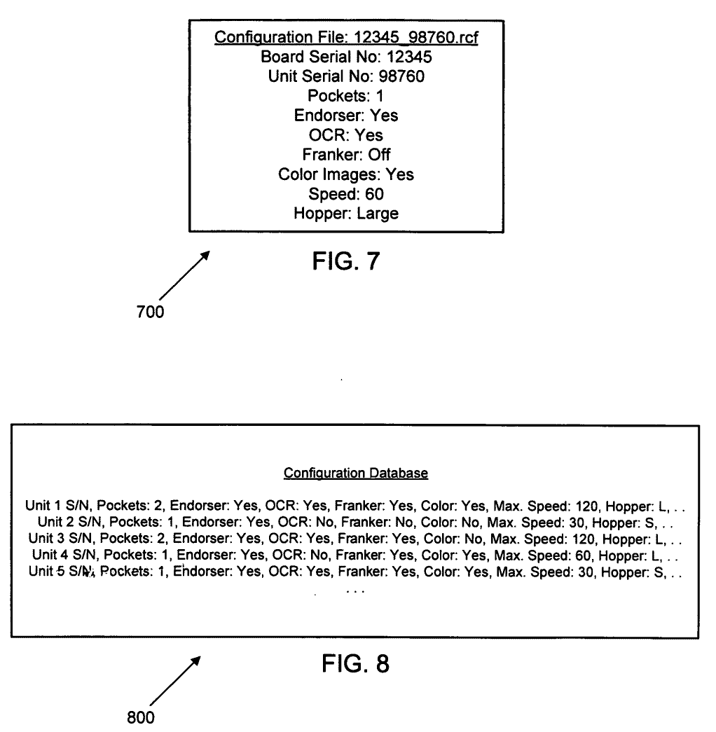

As illustrated in FIGS. 4-5 and described in further detail in FIGS. 7-10 below, each control board 408, 410 stores a unique identifier for that control board, and can also store an identifier of the unit (i.e. document processing device) that the control board is installed within. Each document processing device, such as the document processing device 404, also has a unique identifier associated with it. In certain embodiments, the identifiers of the control boards 408, 410 and the document processing device 404 correspond to serial numbers stored in memory of the device 404 and the control board. As shown, these serial numbers are 5-digit decimal values; however other arrangements can be used as well. In a particular embodiment, the serial numbers are up to 48 characters long, using hexadecimal and/or other alphanumeric characters.

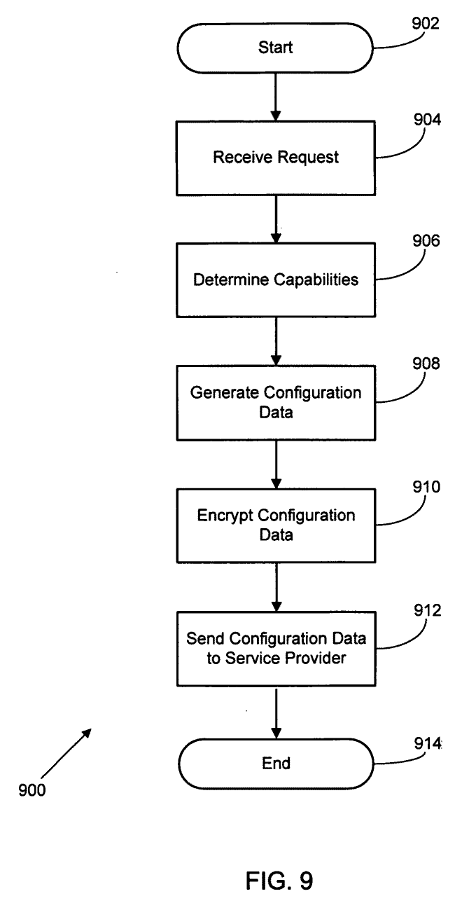

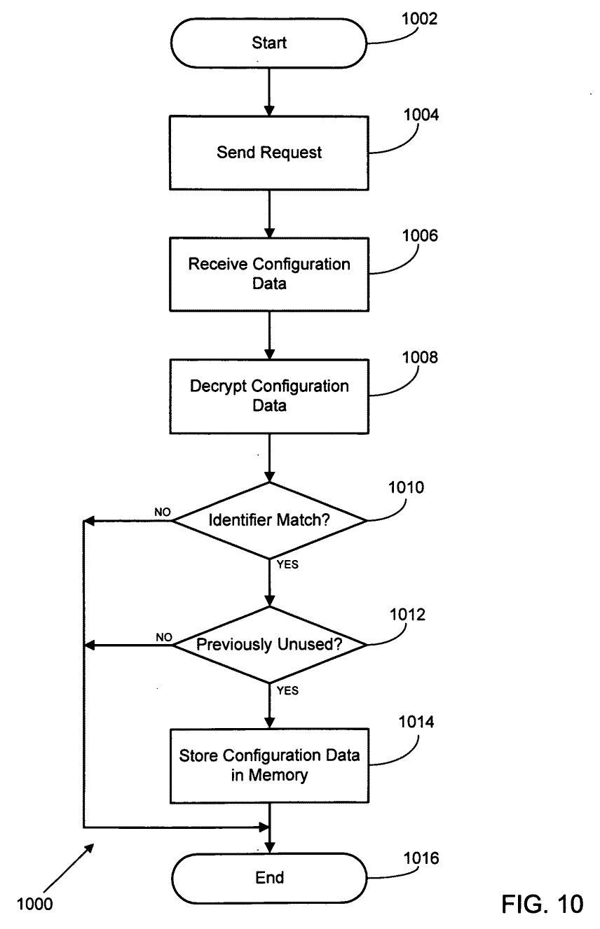

Comparing FIGS. 4 and 5 illustrates beginning and ending states of a control board replacement or reprogramming process according to a possible embodiment of the present disclosure. In FIG. 4, control board 408 has a serial number of ‘00000’ and also stores the unit's serial number, “98760”. This control board 408 corresponds to the control board needing replacement due to malfunction or other failure. The replacement control board, prior to the control board replacement process, stores its own serial number, shown as “12345”. The replacement control board 410 stores a “blank” in the portion of memory generally reserved to indicate the serial number of the unit in which the board is installed; in the embodiment shown, this “blank” is illustrated by a serial number of all 9's, “99999”. The blank unit serial number in the memory of the replacement control board 410 indicates that the board has not previously been used in a device, such as device 404. FIG. 4 can correspond to a beginning state of various methods and systems, such as those described below in conjunction with FIGS. 9-10.

Referring now to FIG. 5, the replacement control board 410 has been installed in the device 404, and reprogrammed to be associated with the device. The replacement control board 410 has stored in its memory the serial number of the unit in which it is installed. FIG. 5 shows the serial number of the device “98760” now stored in memory with the serial number of the board “12345”. The blank serial number “99999” described above has been overwritten, and the old control board 408 has been discarded. FIG. 5 can correspond to an ending state of various methods and systems, such as those described below in conjunction with FIGS. 9-10.

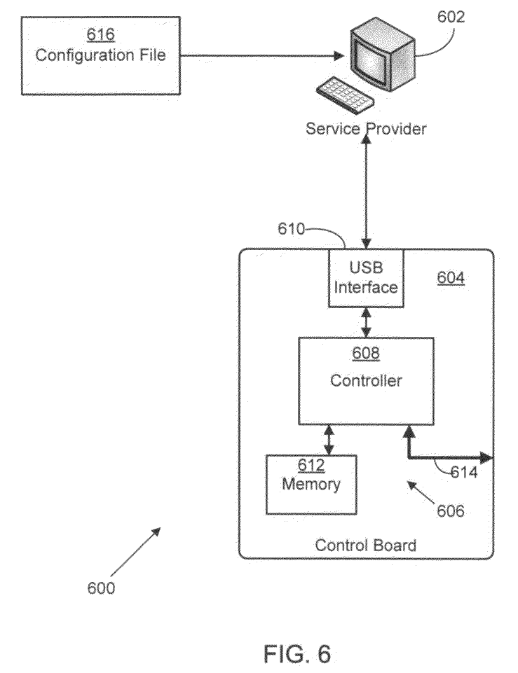

FIG. 6 is a schematic diagram of a system 600 for distribution of configuration data for programming a device, according to a possible embodiment of the present disclosure. The system 600 generally includes a computing system, such as the computing system 602 of a service provider. The computing system 602 generally corresponds to a computing system managed or controlled by the service provider 14 of FIG. 1, and can be any of a number of types of generalized computing systems. The computing system 602 is interfaced with a programmable circuit, shown as a control board 604. The control board 604 can be, in various embodiments generally corresponds to one of the control boards 408, 410 installed into or intended for installation into the device 404 of FIGS. 4-5, above, and can be, for example, used in the document processing system of FIG. 2.

The control board 604 includes a programmable circuit 606, including a controller 608, interface 610, and memory 612. The controller 608 is a circuit configured to execute instructions, such as software instructions residing in the memory 612 of the device. In various embodiments, the controller 608 can be a special purpose controller or a general purpose, programmable controller configured for execution of various actions within the control board 604 and the device in which the control board resides. The interface 610 provides communication between the control board 604 and the computing system 602, allowing the computing system to communicate instructions to the control board for storage in the memory 612 of the control board. In certain embodiments, the interface 610 can be a serial data communication interface, such as a USB or Firewire interface.

The memory 612 is generally any of a number of types of nonvolatile memory from which the controller 608 can execute instructions and can read/write from. In certain embodiments, the memory 612 is a flash memory that contains a software program directing execution of the controller 608, and also configuration data that sets operational parameters for that execution.

The programmable circuit 606 also includes a number of output signals, shown as signal bus 614, configured to provide electronic control connections to various electrical and electromechanical components of the device, such as an image or character scanner, drive mechanism, sorting mechanism, franking roller, or other portion of a document processing system as previously described.

The computing system 602 receives a configuration file 616 via an external network, such as the network 16 of FIG. 1, for storage in the memory 612 of the programmable circuit 606. The configuration file 616 generally includes configuration data, including data which is used to validate use of the control board 604 in the device in which it is installed, as well as data used to set operational capabilities of the control board and device. Example validation-type data can include the various serial numbers of the control board and the device (as stored in the control board). Example data setting operational capabilities of the control board and device can include data enabling, disabling, or setting operational limits on speed/throughput or quality of scanners, printing mechanisms, sensors, or other systems used in the device in which the control board 604 is incorporated. Specific examples are listed in the configuration file of FIG. 7.

Now referring to FIG. 7, an example configuration file 700 is shown which is useable to program a document processing device, according to a possible embodiment of the present disclosure. The configuration file 700 includes various data intended for programming a programmable circuit, such as the programmable circuit resident on a control board of a document processing system, as previously described. The configuration file 700 includes the serial number of the board with which it is to be associated, as well as the serial number of the unit in which the board is currently installed or is to be installed.

The configuration file 700 also includes various operational parameters relating to operation characteristics of the control board and the associated device. In the embodiment shown, the configuration file 700 includes operational parameters relating to a document processing device, including a number of output pockets are incorporated into the device; whether the device has an endorser, whether optical character recognition (OCR) is enabled in the device; whether a franking roller (stamp) is incorporated into and enabled in the device; whether the device can capture color images; at what speed the device can run, in documents per minute; and what size the document intake hopper is in the device. Additional or different operational parameters may be included in the configuration file as well, depending on the specific mechanical configuration of the document processing device.

In the embodiment shown, the configuration file is named using a naming convention identifying both the replacement programmable circuit into which the file will be stored, as well as the device in which the replacement programmable circuit is to be installed. Furthermore, in the embodiment shown, a file extension having a “rcf” extension is used. However, other naming conventions and/or file extensions can be used as well. For example, in certain embodiments the file name may be prefixed with the name of the service provider to aid in visual identification of the file.

Although the configuration file 700 is useable to program a document processing device, it is understood that an analogous configuration file storing alternative configuration data could set operational parameters for a different type of device, such as a printer, scanner, control system, or other device.

FIG. 8 illustrates example data records in a configuration database 800, according to a possible embodiment of the present disclosure. The configuration database 800 generally corresponds to the configuration database 20 of FIG. 1, and is managed by a manufacturer of devices requiring configuration data. The configuration database 800 stores configuration data relating to the various devices which have been purchased by customers of the manufacturer. The configuration database 800 includes a plurality of records of configuration data. In the embodiment shown, each entry (shown as a line) in the configuration database corresponds to data that can be used in a configuration file to be sent to a service provider for configuring a device with a new programmable circuit installed therein, using the methods and systems described herein. The configuration database 800 can be embodied in any of a number of types of databases, such as relational, hierarchical, or flat-file based databases.

When a new programmable circuit requires programming, the manufacturer can access the data in the configuration database 800, using the identification of the device into which the programmable circuit is to be installed. The operational capabilities defined by the entry corresponding to that device are then transferred into a configuration file which can be sent, as needed, to a service provider, who can in turn program an authorized board.

It is understood that the configuration database 800 can include additional information beyond the configuration data. For example, the configuration database 800 can include order information, update information, upgrade information, and other information about customers of the manufacturer.

FIGS. 9-10 illustrate methods and systems for controlling deployment of configuration data to prevent unauthorized reuse of that data or reuse of programmable circuits. FIG. 9 shows a flowchart illustrating a system 900 for controlling deployment of configuration data using the systems and methods of the present disclosure. The system 900 generally corresponds to operations performed by a manufacturer or other source of configuration data (e.g. the manufacturer 12 of FIG. 1) receiving a request from a service provider for configuration data.

The system 900 is instantiated at a start operation 902, which corresponds to beginning of a relationship between a service provider and a manufacturer in which the manufacturer agrees to allow the service provider to replace programmable circuits requiring configuration data in devices made by the manufacturer. For example, the start operation 902 can correspond to a device manufacturer allowing a service provider to service document processing systems by replacing control boards integrated into those devices.

Operational flow proceeds to a request receipt module 904. The request receipt module 904 generally corresponds to receipt of a request for configuration data from a service provider, such as the service provider 14 of FIG. 1. The request receipt module 904 receives a request that includes an identifier of a device and an identifier of a programmable circuit that is to be included in the device and in which the configuration data is to be stored. In certain embodiments, the request receipt module corresponds to action by the manufacturer in response to the send request module 1004 of FIG. 10, performed by a service provider.

In certain embodiments of the system 900, the device to be serviced by the service provider is a document processing system that includes a control board to be replaced, such as is shown in FIGS. 4-5, above. In such systems, the identifiers received from the service provider include the serial number of the new control board to be installed in the document processing device, and the serial number of the document processing device itself. However, other identifiers can alternatively be used to uniquely identify those two components of the system to be serviced.

Operational flow proceeds to a capabilities module 906, which corresponds to a determination of the capabilities which should be allowed in the device to be serviced. In certain embodiments, the capabilities module 906 corresponds to determining operational capabilities of the device based on the contents of a configuration database, such as the configuration databases described above in conjunction with FIGS. 1 and 8. The capabilities module 906 can access a specific record in a capabilities database based on an identifier of a device, and can determine which capabilities (and associated configuration data) are associated with that device.

Operational flow proceeds to a configuration data generation module 908, which generates a file for distribution to the service provider containing the configuration data to be stored in a memory of the device identified in the request received by the request module 904. The configuration data generation module 908 combines the configuration data with validation data including an identifier of the programmable circuit to be included in a device, as well as an identifier of the device itself.

In the embodiments relating to a document processing device, the configuration data generation module 908 creates a file including configuration data setting operational variables for the document processing device for storage in a memory incorporated into a programmable circuit on the control board. The configuration data can also include the serial number of the control board, the serial number of the document processing device. An example of a configuration data file is described above in conjunction with FIG. 7.

Operational flow proceeds to an encryption module 910, which encrypts the configuration data generated by the manufacturer, to prevent unauthorized access of an unencrypted version of the configuration data during transmission of that data to the service provider (or by the service provider itself). Various encryption algorithms can be used to encrypt the configuration data, with it understood that a complementary decryption software package be incorporated into software distributed to the service provider for decryption, validation, and storage of the configuration data in the memory of the identified programmable circuit.

Operational flow proceeds to a transmission module 912, which corresponds to transmission of the (encrypted) configuration data to the service provider. The transmission module 912 can correspond to, in various embodiments, communication between software systems used for programming and maintenance of devices, such as document processing devices. In other embodiments, the transmission module 912 can correspond to use of an email or other electronic message in which the configuration data can be included in a file or other electronic data packet.

Operational flow terminates at an end operation 914, which corresponds with the manufacturer completing transmission of at least one set of configuration data (e.g. a configuration file) to a service provider.

FIG. 10 illustrates a system 1000 for programming a device using the configuration data deployment systems and methods of the present disclosure. The system 1000 generally corresponds to programming of a programmable circuit performed by a service provider after receiving configuration data from a manufacturer. This programming can occur, for example, in the case of repair of the device, or can be initial programming of a circuit within a device by a third party (e.g. not the manufacturer of the device or a party entrusted with the configuration data for that device). In certain embodiments, the system 1000 corresponds to a service provider programming a control board of a document processing device with data received in a configuration file. The system 1000 can be embodied, in whole or in part, in a software system provided by the manufacturer to the service provider for programming a device with configuration data.

Operational flow within the system 1000 is instantiated at a start operation 1002, which corresponds to initial determination that configuration data is needed to complete a configuration of a device. Operational flow proceeds to a send request module 1004, which corresponds to a service provider transmitting a request for configuration data to a manufacturer or other party managing distribution of configuration data relating to the devices serviced by the service provider. The request transmitted from the service provider includes an identifier of the programmable circuit that will store the configuration data, as well as an identifier of the device with which the programmable circuit and configuration data is to be associated. As described in conjunction with FIG. 9, in embodiments in which the service provider is servicing a document processing device, the identifiers include, for example, the serial number of a control board installable into a document processing device and the serial number of the document processing device into which the control board is to be installed.

A configuration data receipt module 1006 corresponds to receipt of configuration data, such as in a configuration data file, from the manufacturer or other manager of configuration data distribution. The configuration data can include an identifier of at least the programmable circuit in which the data is to be stored; in certain embodiments, the configuration data also includes an identifier of the device with which it is to be associated. The configuration data also includes data that defines operational characteristics of the device. An example set of configuration data is described in conjunction with a configuration data file in conjunction with FIG. 7, above.

The configuration data receipt module 1006 can be performed by the software system that generally provides the configuration data to the programmable circuit for storage, in certain embodiments of the present disclosure. In further embodiments, the configuration data receipt module 1006 corresponds to the service provider receiving a configuration data file via email, file transfer (e.g. FTP), a web-based server-client system using software distribution packages, or other data communications protocols or schemes. That data file is subsequently loaded into a utility software package for subsequent use.

Operational flow proceeds from the configuration data receipt module 1006 to a decryption module 1008. The decryption module 1008 decrypts the configuration data received into the software system used to perform aspects of the system 1000, for use in subsequent verifications operations and for storage of the configuration data into memory of the programmable circuit in the device. The decryption module 1008 can use any of a number of decryption algorithms, and generally uses a decryption algorithm complementary to the encryption algorithm used by the encryption module 910 of FIG. 9. It is noted that the decryption module 1008 generally limits storage of the decrypted data, such that decrypted configuration data is generally inaccessible to the service provider and cannot be extracted for reuse with other programmable circuits, devices, or computing systems.

Operational flow proceeds to an identifier matching operation 1010. The identifier matching operation determines whether an identifier stored in memory of a programmable circuit matches with an identifier of that same programmable circuit in the (decrypted) configuration file. In the example of the control board for a document processing device, the identifier matching operation 1010 can be performed by matching a serial number of the control board stored on that board with a serial number of the board stored in the configuration data, received as a configuration data file.

If the identifier matching operation 1010 fails (i.e. there is a mismatch between the serial numbers or other identifiers), this indicates that the configuration data is not intended to be stored in the memory of the programmable circuit, and operational flow branches “no”, causing system failure (i.e. the software systems will not write the configuration data into the memory of the programmable circuit) and leading to an end module 1016. If the identifier matching operation 1010 succeeds, indicating a match between the identifiers, operational flow proceeds to a usage detection operation 1012.

The usage detection operation 1012 determines whether the programmable circuit is impermissibly being reused in a device. The usage detection operation 1012 does so by determining a value of a configuration variable stored in memory of the device. In certain embodiments, the usage detection operation 1012 detects prior usage by reading a value of a device identifier in the memory of the programmable circuit. For example, the usage detection operation 1012 can detect a default value for a serial number identifier for a device, as indicated in the programmable circuit with which the device is associated. If the currently-stored value for the serial number of the device (in the memory of the programmable circuit) is the default value, it can be assumed that the programmable circuit has not previously been used in another device. Therefore, operational flow branches “yes” to a storage module 1014. If the currently-stored value for the serial number of the device is not the default value, it can be assumed that the programmable circuit has previously been used in a different device, and the configuration data should not be written into the memory of that programmable circuit. Therefore, operational flow branches “no” to the end operation, terminating the process (i.e. the software systems will not write the configuration data into the memory of the programmable circuit) and leading to an end module 1016.

Other identifiers of prior use can be implemented in the usage detection operation 1012 as well, such as a flag or other variable set in the memory of the programmable circuit.

The storage module 1014, which executes only upon success of both the identifier matching operation 1010 and the usage detection operation 1012, stores configuration data in a memory of the programmable circuit. The storage module 1014 overwrites the identifier regarding prior use which was analyzed during the usage detection operation to indicate that the programmable circuit has now been programmed and is in use.

In embodiments of the system which operate on a document processing device and related control board, the storage module 1014 stores configuration data from the configuration file (decrypted) into the memory (e.g. flash memory or other nonvolatile memory) on the control board, as illustrated in FIG. 5. The previously-set default identifier, in this case the default serial number of the document processing device, is replaced with the serial number of the device with which the control board is associated, indicating that the control board is now in use and assigned to that device. Subsequent reprogramming attempts relating to that control board will therefore fail based on a failure of the usage detection operation 1012, which will detect the non-default serial number of the device as stored in the memory of the control board.

Operational flow within the system 1000 terminates at an end operation 1016, which corresponds to a completed attempt to store configuration data into a memory of a programmable circuit. In instances where the storage module 1014 is executed, successful storage of configuration data has occurred. In instances where at least one of the identifier matching operation 1010 and the usage detection operation 1012 detects a “failure”, no configuration data is stored in the programmable circuit, either because it is not the approved circuit to receive that information (as determined by the capabilities module 906 and configuration data generation module 908 of FIG. 9) or because the programmable circuit was in prior use in a different device.

Referring now to FIGS. 9-10 generally, it is understood that certain aspects of the systems 900, 1000 can be reordered, such that the various modules and operations of those systems may be performed in a different order. For example, in FIG. 10, the order of the identifier matching operation 1010 and the usage detection operation 1012 may be reversed, with the usage detection operation occurring prior to the identifier matching operation.

Using the methods and systems described above, a number of advantages to a manufacturer or supplier of devices become apparent in providing controlled distribution of configuration data to those devices, where maintenance is outside of the control of that manufacturer/supplier. Specifically, the methods and systems allow a service provider to replace programmable circuits in devices without requiring that they have access to configuration data of those devices, alleviating concerns of reverse-engineering or reuse of the configuration data. Furthermore, the methods and systems of the present disclosure allow the manufacturer or supplier of a device to ensure that proper configuration data is used with each device, allowing that manufacturer or supplier to ensure that the device is being used properly and safely.

Furthermore, a number of advantages exist for service providers based on the methods and systems of the present disclosure. For example, the service provider can purchase and stock a number of replacement parts (programmable circuits, control boards, etc.) prior to a required service instance, minimizing delays in maintenance turnaround times and obtaining the benefit of bulk shipping and purchasing discounts.

Although the various embodiments of the present disclosure relate primarily to reprogramming of control boards in document processing systems, the present disclosure is not so limited. The above-disclosed methods and systems can be used to store configuration data in a memory of a programmable circuit used in any of a number of devices, such as printers, scanners, electronic control units, or other similar devices.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method of controlling distribution of configuration data, the method comprising:
receiving a request for configuration data for storage in a memory of a programmable circuit useable in a device, the configuration data controlling one or more operational characteristics of the device;
determining operational capabilities of the device based on the contents of a configuration database; and
generating a single-use configuration data file, the configuration data file containing configuration data including:
an identifier of the device;
an identifier of the programmable circuit; and
configuration data configured to define operational characteristics of the device.

2. The method of claim 1, further comprising transmitting the single-use configuration data file to a service provider.

3. The method of claim 1, further comprising, upon identifying the programmable circuit and the device, storing the configuration data in a memory of the programmable circuit.

4. The method of claim 1, further comprising encrypting the configuration data file.

5. The method of claim 1, wherein the device is a document processing device.

6. The method of claim 1, wherein the identifier of the device is a serial number of the device.

7. The method of claim 1, wherein the configuration data includes data regarding operational characteristics of components selected from the group consisting of:
optical character recognition systems;
color image scanners;
document endorsers;
document feed systems;
document sorting systems; and
document stamping mechanisms.

8. A method of controlling distribution of configuration data, the method comprising:
receiving a single-use configuration data file containing configuration data including:
an identifier of the device;
an identifier of the programmable circuit; and
configuration data configured to define operational characteristics of the device;
determining a match between the identifier of the programmable circuit in the configuration data file and an identifier of the programmable circuit in a memory of the programmable circuit; and
determining whether the programmable circuit has previously been used.

9. The method of claim 8, further comprising decrypting the single-use configuration data file.

10. The method of claim 8, further comprising, upon determining a mismatch between the identifier of the programmable circuit in the configuration data file and an identifier of the programmable circuit in a memory of the programmable circuit, preventing storage of the configuration data in a memory of the programmable circuit.

11. The method of claim 8, further comprising, upon determining that the programmable circuit has previously been used, preventing storage of the configuration data in a memory of the programmable circuit.

12. The method of claim 8, further comprising storing the configuration data in the memory of the programmable circuit installed in a device.

13. The method of claim 8, further comprising requesting configuration data from a manufacturer of the programmable circuit.

14. The method of claim 8, wherein the configuration data includes data regarding operational characteristics of components selected from the group consisting of:
optical character recognition systems;
color image scanners;
document endorsers;
document feed systems;
document sorting systems; and
document stamping mechanisms.

15. A system for controlling distribution of configuration data defining operational capabilities of a device, the system comprising:
an identifier matching module configured to determine a match between an identifier of a programmable circuit in a configuration data file and an identifier of the programmable circuit in a memory of the programmable circuit;
a use detection module configured to determine whether the replacement programmable circuit has previously been used; and
a storage module configured to store configuration data from the configuration data file into the memory of the programmable circuit.

16. The system of claim 14, further comprising a receipt module configured to receive a configuration data file.

17. The system of claim 14, wherein the programmable circuit is a replacement control board useable in a document processing device.

18. The system of claim 17, wherein the memory is a flash memory incorporated onto the replacement control board.

19. The system of claim 17, wherein the identifier of the programmable circuit is a serial number assigned to the replacement control board.

20. The system of claim 14, wherein the device is a check processing device.

21. A system for controlling distribution of configuration data defining operational capabilities of a device, the system comprising:
a request receipt module configured to receive a request for configuration data, the configuration data used for storage in a memory of a programmable circuit useable in a device and controlling one or more operational characteristics of the device;
a determination module configured to determine operational capabilities of the device based on the contents of a configuration database;
a generation module configured to generate a configuration data file containing configuration data including:
an identifier of the device;
an identifier of the programmable circuit; and
configuration data configured to define operational characteristics of the device.

22. The system of claim 21, further comprising an encryption module configured to encrypt the configuration data file.

23. The system of claim 21, further comprising a transmission module configured to transmit the configuration data file to a service provider.

24. The system of claim 21, wherein the configuration database contains configuration data regarding a plurality of devices.

25. The system of claim 21, wherein the device is a check processing device.
